(19) United States
(12) Patent Application Publication
(10) Pub. No.: US 2005/0169692 A1
(43) Pub. Date: Aug. 4, 2005

(54) Advertising ball point pen

(76) Inventor: Werner Demetz, Zurich (CH)

Correspondence Address: JOHN W. RYAN;C/O DECHERT LLP, PRINCETON PIKE CORPORATION CENTER, P.O. BOX 5218, PRINCETON, NJ, 08543-5218, US

(21) Appl. No.: 11/050,167

(22) Filed: Feb. 2, 2005

Related U.S. Application Data
(63) Continuation of application No. 10/344,218, filed on Feb. 10, 2003.

(51) Int. Cl. B43K 7/00

(52) U.S. Cl. 401/209

(57) ABSTRACT

A writing instrument such as a ball point pen that includes an elongated tubular housing and a ball point pen tip connected to the housing for writing purposes and a lenticular image display surface that includes a pair of different composite images suitable for advertisement or indicia information in the same area on the outside surface of the writing instrument body, said lenticular display including a plurality of grooves making the pen easier to grasp and hold during writing.

### CROSS REFERENCE TO RELATED APPLICATION

This application is a continuation of U.S. patent application Ser. No. 10/344,218, filed Feb. 10, 2003 and titled “IMPROVED ADVERTISING BALLPOINT PEN,” which application is hereby incorporated by reference into the instant application.

### BACKGROUND OF THE INVENTION

1. Field of the Invention

This invention relates generally to a writing instrument that can be used for indicia display, such as for advertising, and specifically to a writing instrument, such as a ball point lenticular lens display system affixed to the outer surface of the writing instrument housing.

2. Description of Related Art

Writing instruments have long been utilized as a popular form of advertisement for businesses. In particular, often a corporate name or logo is printed on the surface of a writing pen. U.S. Pat. No. 5,086,577 issued to Abernethy Feb. 11, 1992 shows a writing instrument advertisement device. U.S. Pat. No. 4,787,161 issued Nov. 29, 1988 to Feng shows an advertisement writing instrument that can clamp to a user's pocket for display.

It is also desirable for a writing instrument such a s a ballpoint pen to have a non-slip surface for ease in writing when grasping a pen body in the hand and digits of the user.

Advances in the design and manufacture of lenticular optical systems have lead to the increased use of lenticular lens arrays. Lenticular lenses are well known in the art for use in pen, that has two or more optical displays produced by a optical systems to produce various types of optical affects. A lenticular optical system in the prior art generally includes a transparent sheet having a planar surface on one side and on the other side, a series of parallel, longitudinal, convex curved ridges separated by parallel grooves forming a multi lenticular system of convex lenses. A printed sheet of indicia is typically disposed behind the lens adjacent to the planar surface. The printed sheet contains at least two alternative series of spaced image lines constituting a dissection or break-up of a master image. The series of spaced image lines are optically related with respect to the lens elements as to be alternately visible upon positional changes of the observer with respect to the lenses and images. When viewed from a first position, a first series of image lines are visible and a first composite image is observed. When viewed from a second position, a second (different) series of image lines are visible and display a second (different) composite image. U.S. Pat. No. 2,815,310 issued to Anderson discloses an example of a dual image lenticular optical system.

Further advances in lenticular optical systems have resulted in an increasing of observable sets of images available. The increase in observable sets has made lenticular animation possible. Therefore, as the observer moves relative to the lenticular lens array viewing screen, a series of pictures comes successively into view thus creating the impression of continuous changes in the phases of motion. Accordingly, current lenticular optical technology is capable of producing a composite image in a series of N scenes resulting in an animation picture when viewed properly at successive viewing angles. In addition such technology may be used to display a wide variety of useful information, such as account information, telephone numbers, and e-mail addresses, as examples.

The production of images which change with a change in viewing angle has been known for many years. It is described, for example, by A. G. Anderson in U.S. Pat. No. 2,815,310. The images are produced on opaque or transparent sheets of material such as paper, paper board, or plastic. The resulting imprint, in black and white or color, is laminated to a transparent lenticular lens. Alternatively, a transparent plastic carrier may be printed on its reverse side and viewed through a lenticular lens face of the carrier.

A lenticular screen, as is well known, has a number of lenses arranged in side-by-side relationship. Each lens, commonly termed a lenticle, may be formed by an elongated or circular convex frontal surface, and a flat rear surface.

The printed image is formed by two interleaved pictures producing a grid of parallel lines with alternating striations. The pitch, or number of picture-element pairs per unit distance, must be the same as the lens pitch of the lenticular array. In addition, the focal length of each lenticle should be equal to the thickness of the lenticular sheet. Under these conditions, at one viewing angle an observer will see only one picture, while at a different angle the same observer will see the other picture.

The requirement that the picture elements be in registration with the lenticular array complicates the printing and lens forming steps. In practice, the pitch of the lenticular assembly is limited to a spacing that is equivalent to 39 lenticles per centimeter (100 lenticles per inch), or less. Even with 19-39 lenticles per centimeter (50-100 lenticles per inch), it is difficult to hold the registration over widths of more than a few inches. This limitation restricts the quality of pictorial resolution, as well as size.

The focal length of the lenticles must equal the thickness of the lenticular sheet. At a pitch of 39 lenticles per centimeter (100 lenticles per inch), assuming a half cylinder lenticular surface, the focal length for a conventional plastic sheet, having refractive index of 1.5 to 1.6 is 0.0406 to 0.048 centimeter (0.016 to 0.019 inches).

U.S. Pat. No. 4,870,768 to Watt discloses a display device comprising a plurality of lenses disposed in a concavely curved lens array, and a plurality of substantially curved pictures associated with the lenses. The resulting array can be disposed around a writing instrument such as a ball pen. However, the display device disclosed in Watt requires substantially concavely curved images that are individually associated with individual lenses from the lens array. This complex optical arrangement requires sophisticated manufacturing processes that add to the cost of the entire device, and are unpractical to apply at a large scale.

Currently there exists a need for a cost-effective writing instrument such as a ball point pen that can be used to display advertisements and to have multiple different image displays available on a single instrument.

### BRIEF SUMMARY OF THE INVENTION

The present invention provides for an improved writing instrument such as a ballpoint pen, ink pen, pencil or stylus that also has two or more viewable indicia displays including pictorial, graphic or alphanumeric information disposed on the outside body of the writing instrument for informational, advertising, or entertainment purposes.

A writing instrument such as a ball point pen that includes a substantially cylindrical elongated housing, a barrel that is an ink reservoir and projecting from one end of the barrel, a ball point writing tip. A barrel support is disposed within the elongated tubular housing. A pen tip activating mechanism including an activating cap allows the ball point tip to be retracted or extended from one end of the housing manually.

Attached to the outer surface of the tubular housing is a lenticular lens dual image display system that includes a plurality of convex lens surfaces separated by circular grooves dispersed laterally around the pen body outer surface. The lens material is a translucent and clear plastic. Disposed directly on the outside body surface of the pen or on the planar lower surface of the lens body is the indicia images used with the lenticular lenses that includes two separate ink images critically aligned relative to the lenticular convex lens surfaces such that an observer would be able to observe at least two visual images or pictures disposed on the portions of the ball point pen exterior surface by relatively moving the pen body with respect to the observer's point of view (eyes). Therefore, the ball point pen tubular body includes, attached to its outer surface of the pen housing, a lenticular lens array and at least two different images. The lenticular lens array forms a lenticular optical system capable of displaying animated images, alpha numeric information, advertising material, or other useful information. The actual image lenses may be on paper, glued to the pen body or painted directly on the surface of the pen or lens. The invention may include at least a portion of the pen body surface that comprises a transparent lenticular display.

The ball point pen and ink transfer to paper operates in a normal way, while the lenticular lens optical system also helps holding the outer pen surface because of the lenticular circular grooves disposed parallel to the cross section of the pen body length. The grooves are spaced apart in such away as to aid and improve non-slip on the grasping surface for the hand and digits for holding the pen. This is caused by a plurality of convex lens surfaces that are separated by lenticular lens grooves that are circularly presented around the body of the writing instrument such as a ballpoint pen. The pen may also include a rubber holding portion near the tip for the extreme ends of the thumb and index finger while holding the pen near the tip.

It is an object of the present invention to provide a writing instrument, such as a ballpoint pen, that includes a lenticular lens optical display system on its outer body for indicia display.

Another object of the present invention is to provide a writing instrument that includes an lenticular lens array capable of displaying a wide variety (at least two or more) of images and/or information on the outside surface of the writing instrument body.

Yet another object of the present invention is to provide a manual writing instrument with an lenticular lens array that is manufactured to standard writing instrument specifications and sizes for use manually that includes dual image indicia and lenticular outer lens surfaces and grooves for non-slip grasping.

In a preferred embodiment, the present invention provides a writing instrument to provide an advertisement or informational display comprising an elongated writing instrument body, a writing element connected to said body to allow the user to use the device as a writing instrument, characterized in that said writing instrument further comprises a lenticular display system mounted to the outer surface of the writing instrument body, said lenticular display system comprising:
a plurality of convex lenses, separated by grooves for easier grasping on the outside, and whose lower surface is planar and corresponds to the curvature of the outer surface of the writing instrument body.
at least two different images observable from outside through the convex lenses at different view angles, and disposed directly on the lower surface of the plurality of convex lenses or on the outer surface of the writing instrument body.

Said writing instrument may alternatively be a ballpoint pen, a fibre tip pen, a pencil, a marker, a felt pen, a crayon, a roller gel pen, a fountain pen or any other type of writing instrument.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 shows a side elevational view of the present invention with the ballpoint tip extended.

FIG. 2 shows a front elevational view of the present invention as shown in FIG. 1 with the ballpoint pen retracted rotated 90 degrees from the view of FIG. 1.

FIG. 3 shows an enlarged side elevational view of the present invention portion of its body for explanatory reasons.

FIG. 4 shows a cut away segment of the surf ace of the ballpoint pen, the indicia disposed thereon, and a portion of the lenticular lenses in cross section.

### PREFERRED EMBODIMENT OF THE INVENTION

Referring now to the drawings and in particular FIG. 1, the present invention is shown generally at 10 including a ball point pen tubular plastic or metal body 12 which is an elongated tube having a conical rubber or synthetic rubber-like grasping tip 30. The conical tip 30 may include a plurality of semispherical recesses 32 oriented about the tip surface 30 for easier grasping. Inside of the ball point pen housing 12 is a barrel 20 which is an ink reservoir that has a ball point pen tip 28 connected at the end for writing purposes. The ballpoint pen 10 includes a mechanism inside the housing 12 which includes a spring lock so that manual depression of button 18 causes the writing element 28 to be retracted or extended depending on the position of the mechanism. The ballpoint pen itself is conventional in operation and may include a pocket clip-on 16. The housing 12 may be made of metal or plastic.

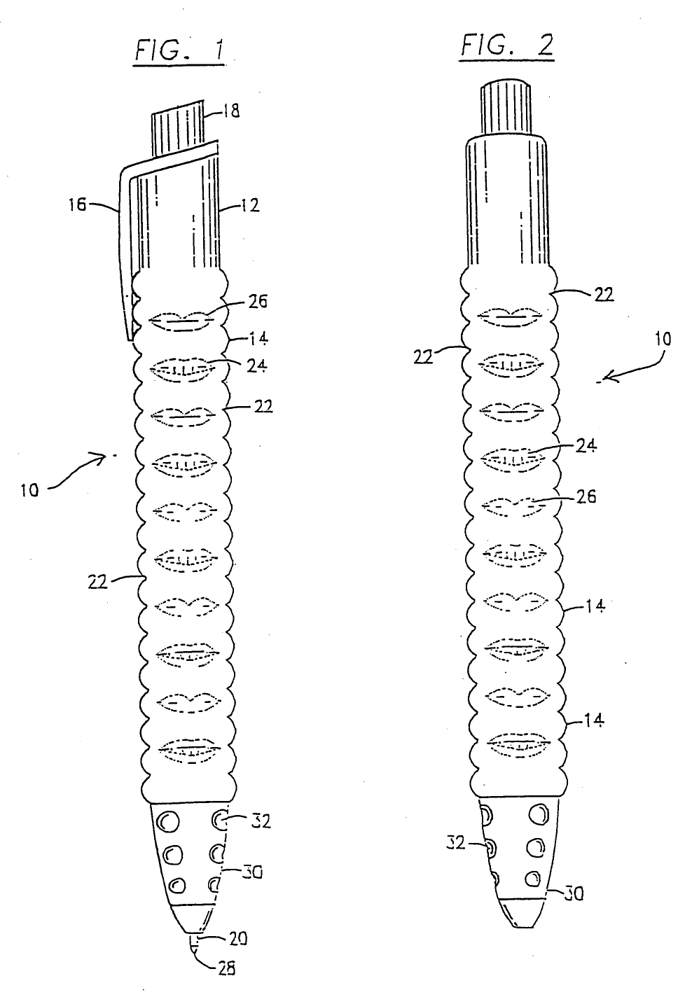

Affixed to the outer housing 12 is dual image indicia 24 and 26 which as an illustration shows a human set of lips both open and closed. The open lips image indicia 24 show human teeth while image indicia 26 shows a pair of closed lips. The images 24 and 26 change when the pen body is moved relative to the observer's optical line of sight. These images 24 and 26 are disposed about the surface of the body 12 by painting or gluing paper or plastic image indicia onto the outer surface 12. Disposed on top of the indicia 24 and 26 is a plurality of convex lenses 14 separated by grooves 22 that are disposed laterally around the circular body of the ballpoint pen 10. Each circular groove 22 basically forms a plane that is perpendicular to the longitudinal axis of the ballpoint pen. Each of the grooves 22 extends circularly around and separates the adjacent convex lenses 14 forming the lenticular display system. FIG. 2 shows the same view of the pen shown in FIG. 1 only at 90 degrees therefrom again including indicia 24 and 26. Each image is made up of two sets of lines and contains both image 24 and image 26 at each image location. Moving the pen body produces movement of the lips 24 and 26 between an open lip display and a closed lip display, as results from the lenticular lens 14. For the sake of example, the lenticular lens surface areas have been exaggerated in size and would be much, much smaller when observed. Also in FIG. 2, the ballpoint pen writing tip shown in FIG. 1 as element 28 has been retracted. Each pair of lips shown on the pen 10 in FIGS. 1 and 2 contain both images 24 and 26.

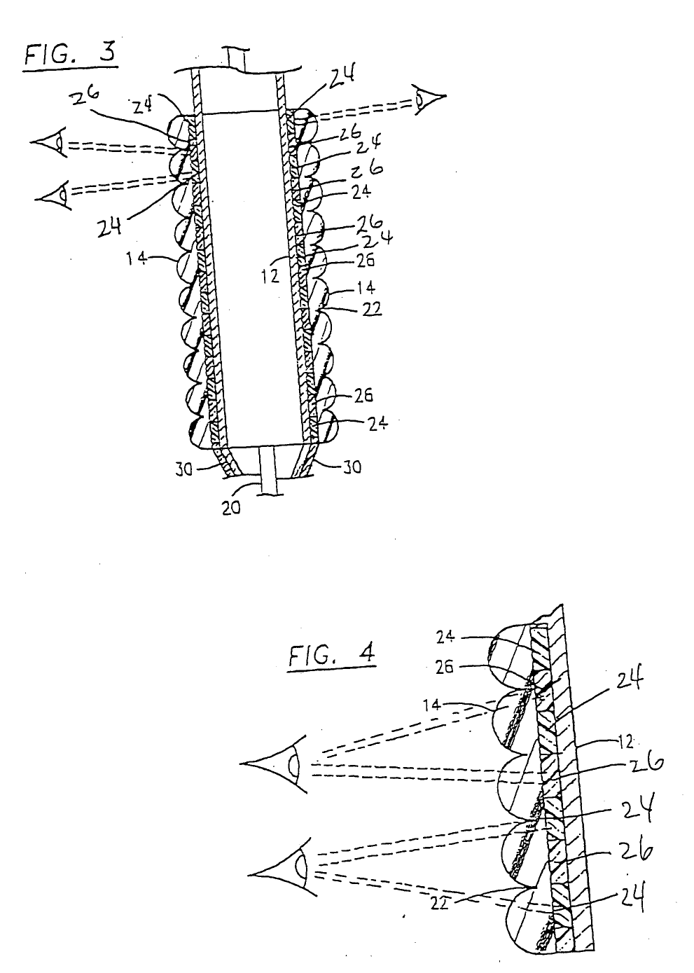

Referring to FIG. 3, the ballpoint pen body 12 is shown in cross section but has affixed to its surface two different image lines 24 and 26 relative to each of the lenticular convex lenses 14. Basically when a person observes the image lines 24 or 26, because of the lenticular convex lenses 14 and their separation by grooves 22, at one position the eyes would perceive one set of image lines 26 showing a pair of lips that are closed. Movement of the pen body relative to the observer would then show the same area but different image 24 that the lips are open and displaying teeth. Closing and opening motion is also perceived by moving the pen body. Any types of two different images can be presented whether it is alphanumeric information, letters, corporate logos or other data that could be useful to someone that is utilizing the ballpoint pen.

As shown in FIG. 3, the eye is capable of looking at either indicia 26 or 24 depending upon the relative location of the ballpoint pen body.

Note that in the drawings, the convex lens surfaces 14 and grooves 22 are exaggerated in size and are much smaller on the actual pen. The pen body lens surface exterior has a non-smooth surface which aides in grasping a pen during a writing operation.

FIG. 4 shows the pen body 12 having affixed to its outer surface indicia images 24 and 26 which are sized and used in conjunction with the lenticular optical system 14 at the same area of the pen body. Lenticular convex lenses 14 are separated by the grooves 22 which allow an observer to see either the indicia image lines 24 or alternatively indicia image lines 26. As stated in the above example, the images 24 and 26 are an animated pair of lips in a closed position, which then opens to an open position exposing the lips and teeth. Motion is detectable between the two images while changing the viewing angle. As diagrammatically illustrated in FIGS. 3 and 4, the series of spaced image indicia lines 24 and 26 are optically related with respect to the lens elements as to be alternately visible upon positional changes of the observer with respect to the lenses. For example, when viewed from a first observer position, a first series of image lines 24 are visible and display of a first composite image 24 is viewed. Specifically when viewed from another observer position, the optical lines of sight are refracted by convex lenses 14 towards first image line so that the observer sees the image lines 24 coherently and comprehensively corresponding to the image presented by all first image lines. When viewed from a second observation position, a second series of image lines 26 are visible and display a second composite image 26 overall. Similarly, when viewed from a second observation position, the optical lines are refracted by convex lenses 14 towards the second image lines 26 so that the observer sees a coherent and comprehensive image 26 corresponding to an image represented by the second image lines.

As previously discussed, advances in lenticular optical systems have resulted in an increase in the number of images that include animation for use with lenticular lenses. The increase in observer image sets has made lenticular animation possible. Therefore as the observer moves relative to the lenticular viewing screen, a series of pictures come successively into view, bringing the appearance of continuous changes in the phases of motion. Accordingly, to the extent that the disclosure and diagrammatic representation here may be limited to first and second image sets, the present invention may include the use of large number of observable images such as to achieve animation. While the preferred embodiment of the invention contemplates a lenticular lens having a series of convex lenses, it is contemplated that any suitable lenticular lens structure within the scope of the present invention is possible.

In an alternate embodiment and the lenticular lens may cover only a small portion of the ballpoint pen body surface for informational purposes.

Although the writing instrument shown here is a conventional ball point pen, a fountain pen or pencil or other type of writing instrument including electronic devices could be utilized by affixing the proper lenticular lens system to the outer surface for display. Although the lenticular lens system is shown with the grooves running laterally circularly around the ball point pen body, a lenticular pen display could be arranged so that the grooves run longitudinally along the outer surface which will change the viewing angle 90 degrees.

The instant invention has been shown and described herein in what is considered to be the most practical and preferred embodiment. It is recognized, however, that departures may be made therefrom within the scope of the invention as claimed.

1. A writing instrument for providing an informational display, comprising:
an elongated writing instrument body;
a lenticular display system mounted to the outer surface of the writing instrument body, the lenticular display system including a plurality of convex lenses, which are separated by circular grooves disposed laterally around the writing instrument body; and
at least two different images formed on paper, which adheres to an outer surface of the writing instrument.

2. The writing instrument of claim 1, wherein the writing instrument body is a ball point pen.

3. The writing instrument of claim 1, wherein the writing instrument body is a fiber tip pen.

4. The writing instrument of claim 1, wherein the writing instrument body is a pencil.

5. The writing instrument of claim 1, wherein the writing instrument body is a marker.

6. The writing instrument of claim 1, wherein the writing instrument body is a felt pen.

7. The writing instrument of claim 1, wherein the writing instrument body is a crayon.

8. The writing instrument of claim 1, wherein the writing instrument body is a roller gel pen.

9. The writing instrument of claim 1, wherein the writing instrument body is a fountain pen.

10. The writing instrument of claim 1, further comprising a writing element connected to the writing instrument body to allow the user to use the device as a writing instrument.

11. The writing instrument of claim 1, wherein at least two said different images are observable through the convex lenses at different view angles.

12. A writing instrument for providing an informational display, comprising:
an elongated writing instrument body;
a lenticular display system mounted to the outer surface of the writing instrument body, said lenticular display system including a plurality of convex lenses which are separated by circular grooves, wherein each of said circular grooves forms a plane that is perpendicular to the longitudinal axis of the writing instrument body; and
at least two different images formed on paper, which adheres to an outer surface of the writing instrument.

13. The writing instrument of claim 12, further comprising a writing element connected to the writing instrument body to allow the user to use the device as a writing instrument.

14. The writing instrument of claim 12, further comprising at least two different images disposed on the outer surface of the writing instrument body and observable through the convex lenses at different view angles.

15. The writing instrument of claim 12, wherein the writing instrument body is a ball point pen.

16. The writing instrument of claim 12, wherein the writing instrument body is a fiber tip pen.

17. The writing instrument of claim 12, wherein the writing instrument body is a pencil.

18. A writing instrument for providing an informational display, comprising:
an elongated writing instrument body;
a lenticular display system mounted to the outer surface of the writing instrument body, said lenticular display system including a plurality of convex lenses, which are separated by circular grooves and disposed parallel to the cross-section of the writing instrument body; and
at least two different images formed on paper, which adheres to an outer surface of the writing instrument.

19. The writing instrument of claim 18, wherein at least two different images are observable through the convex lenses at different view angles.

20. The writing instrument of claim 18, wherein said lower surface of said grooves is planar and corresponds to the curvature of the outer surface of the writing instrument body.
